(19) United States
(12) Patent Application Publication
(10) Pub. No.: US 2008/0271669 A1
(43) Pub. Date: Nov. 6, 2008

(54) POLYMERIC COVER FOR ROBOTS HAVING AN INCREASED TOTAL SURFACE ENERGY

(75) Inventor: Frank L. Butterworth, Upland, IN (US)

Correspondence Address: BAKER & DANIELS LLP, 300 NORTH MERIDIAN STREET, SUITE 2700, INDIANAPOLIS, IN, 46204, US

(73) Assignee: Butterworth Industries, Inc., Gas City, IN (US)

(21) Appl. No.: 12/056,695

(22) Filed: Mar. 27, 2008

Related U.S. Application Data
(63) Continuation-in-part of application No. 11/691,828, filed on Mar. 27, 2007.

(51) Int. Cl. B32B 37/00; B32B 3/02; B05C 5/00

(52) U.S. Cl. 118/300; 428/76; 156/272.2; 156/220

(57) ABSTRACT

The present invention involves cover for robots having spray nozzles wherein the surface material of the covers have been enhanced for residue retention. The robot covers of the present invention may be formed from a polymer, which in one exemplary embodiment may be polyethylene. For example, the polymer may be received in the form of a cast or blown extruded plastic film. In one exemplary embodiment, the polymer may be processed to increase the surface energy and/or surface area of the polymer. By increasing at least one of the surface energy and the surface area of the polymer, the total energy of the surface of the polymer is increased.

### CROSS-REFERENCE TO RELATED APPLICATIONS

This application is a continuation-in-part of co-pending U.S. patent application Ser. No. 11/691,828, filed Mar. 27, 2007, entitled POLYMERIC COVER FOR ROBOTS, the entire disclosure of which is hereby expressly incorporated herein by reference.

### BACKGROUND

1. Field of the Invention

The present invention relates to covers for automation equipment and particularly to covers for robots having spray nozzles.

2. Description of the Related Art

Robots and other types of automation equipment are commonly used in various industrial applications to perform constant, repetitive tasks. For example, a robot may be placed on an assembly line to weld together or paint parts moving therealong. When painting a part moving along an assembly line, for example, a robot may spray the paint directly onto the moving part. This may result in a portion of the paint, which is atomized by the spraying, being emitted into the surrounding air without physically contacting the part, i.e., overspray. To help contain this atomized paint, a booth may be erected around the painting operation on the assembly line. The booth helps to contain the atomized paint and prevents the same from contacting other machinery located along or parts moving down the assembly line. As the atomized paint moves through the air within the paint booth, it may encounter other atomized paint, dust, or other debris. As a result, the various particles may adhere to one another and, ultimately, fall from the air. The combined particles may then land anywhere within the paint booth, such as on a freshly painted surface or a painting robot. Alternatively, the atomized paint may simply drift into an object, such as a painting robot, within the paint booth.

Over time, the continual contact of atomized paint with a painting robot may create enough paint layers to result in the release of some of the paint from these layers onto the surface being painted. Thus, additional maintenance work to remove the paint, such as stripping the paint from the robot, may be needed. Additionally, when atomized paint combines with other particles, the contact of the combined particles with a freshly painted surface may require repainting that surface. To prevent the build up of paint on a painting robot and remove the atomized paint from the air of a paint booth, robot covers may be used. A robot cover surrounds the painting robot and prevents paint from accumulating on the surfaces thereof. Additionally, the cover may retain the paint thereon to prevent the atomized paint from continuing to travel through the painting booth.

Robot covers may be manufactured from fibrous material, such as cotton, nonwovens, polyester or nylon knits, or wovens, which are capable of retaining a significant amount of paint thereon. However, fibrous material readily releases particles, i.e., lint, into the surrounding air. If these particles are released in a paint booth, for example, the particles may encounter a freshly painted surface and create a defect thereon, potentially requiring that the surface be repainted or repaired. Alternatively, robot covers may be manufactured from polymers, which substantially eliminate the release of fibrous particles from the robot cover. However, polymers that have a sufficient wear resistance to withstand the continual movement of the robot generally have low wettability and adhesivity for paint and/or other fluids. Additionally, polymers having both sufficient wear resistance and sufficient wettability and adhesivity are prohibitively expensive for use as a robot cover.

What is needed is an improvement over the foregoing.

### SUMMARY

The present invention relates to automation covers and, particularly, to covers for robots having spray nozzles wherein the surface material of the covers have been enhanced for residue retention. The robot covers of the present invention may be formed from a polymer, which in one exemplary embodiment may be polyethylene. For example, the polymer may be received in the form of a cast or blown extruded plastic film. In one exemplary embodiment, the polymer may be processed to increase the surface energy and/or surface area of the polymer. By increasing at least one of the surface energy and the surface area of the polymer, the total energy of the surface of the polymer is increased. For example, the polymer may be subjected to a corona treatment in order to increase its surface energy. In other exemplary embodiments, the polymer may be subjected to flame treatment, plasma modification, surface grafting, acid oxidation, radiation induced oxidation, laser treatments, ion beam treatments, metallization, and/or sputtering to increase its surface energy. Additionally and/or alternatively, the polymer may be subjected to an embossing process in order to increase its surface area. In other exemplary embodiments, the polymer may be subjected to roughening, such as by wire-brushing, sanding, or sand blasting, etching, embedding of particulate or fibrous material in the polymer resin, and/or chemical modification.

In one exemplary embodiment, the polymer may be subjected to thermal molding to increase its surface energy and/or surface area. In another exemplary embodiment, the process used to increase the surface energy and/or surface area is performed on the polymer as received, prior to cutting or otherwise manipulating the polymer. In another exemplary embodiment, the process used to increase the surface energy and/or surface area is performed by the manufacturer or converter of the polymer prior to receipt of the polymer.

Once processed, the polymer may then be assembled into a robot cover. To assemble the polymer into a robot cover, the polymer may be cut into individual sections or subjected to tubular extrusion prior to assembly. Additionally, the individual sections and/or tubular extrusion may be further cut, perforated into rolls, or sealed together. In one exemplary embodiment, the polymer is then assembled by thermal sealing the sections together. Thermal sealing provides a bond between the individual sections of polymer that secures the individual sections together to create the robot cover. Additionally, during assembly, the sections may be sewn, stitched, glued, thermally molded, pressure molded, vacuum molded, blow molded, laser welded or ultrasonic welded to secure the sections together. Further, the methods of increasing the surface energy and/or surface area of the present invention may be used to form drapes or curtains for a paint shop booth and/or wall and window covers, for example.

Advantageously, by increasing the surface energy of the polymer, such as by corona treating the surface of the polymer, the wettability and adhesivity of the polymer's surface is increased to enhance its ability to retain residue. As a result, fluids, including but not limited to paint, primer, clear coat, adhesives, coatings, and/or other depositions, contacting the robot cover of the present invention may be more readily retained thereon. This allows the atomized paint in a paint booth, for example, to be retained on the robot cover as it dries. Additionally, by increasing the surface area of the polymer, such as by embossing the polymer, the amount of paint capable of being retained thereon is increased. For example, by embossing the polymer a plurality of ridges and valleys may be created that increase the effective surface area of the polymer. Other embossing techniques, including but not limited to grit, diamond, or honeycomb shapes, may be used to increase the effective surface area of the robot cover. In turn, the increase in the effective surface area facilitates the dispersion of the paint over a larger area, increasing the ability of the polymer to retain paint thereon. As a result of increasing the surface energy and/or surface area of the polymer, the total energy of the surface of the polymer is increased. This allows the robot cover of the present invention to provide an enhanced barrier between or an additional masking of a robot from the atomized paint of the painting booth.

Additionally, using an extruded, cast, molded or liquid polymer to manufacture robot covers is less expensive and mitigates against fibrous material, included but not limited to cotton, nonwovens, polyester or nylon knits, or wovens being readily released as particles, i.e., lint, into a paint booth. The particles released from the fibrous material of a robot cover may encounter a freshly painted surface, potentially requiring that the surface be repainted or repaired. Such polymer material may be easily formed into tubular sections or laminar sheets that easily accommodate manufacture into a robot cover, and alternatively polymer material may be molded via a thermal, pressure, vacuum, or blow molding process to be structured and arranged to envelop a robot, a robot arm, a robot axis, or other robot components. Moreover, by thermal sealing, sewing, stitching, gluing, laser welding and/or ultrasonic welding the seams of a robot cover made from a polymer, the cost of manufacture and maintenance of the robot cover may be substantially decreased. Additionally, the lower material cost of the polymer allows the cover to be readily replaced without the need to rework or otherwise clean the cover, further decreasing the manufacturing costs, as well as associated maintenance costs.

In one form thereof, the present invention provides a cover configured for receipt on a spraying device of a robot, the spraying device adapted to disperse a fluid, the cover including: a first portion of flexible polymer structured and arranged to envelop at least a portion of the spraying device of the robot, the polymer having an outer surface, the outer surface having at least one of an increased surface area and an increased surface energy, wherein the at least one of the increased surface area and the increased surface energy of the outer surface facilitates the retention of sprayed fluid thereon.

In another form thereof, the present invention provides a combination including: a robot having a base and a spraying device, the spraying device configured to disperse a fluid; and a cover having a first portion of polymer structured and arranged to envelop at least a portion of the spraying device of the robot, the polymer having an outer surface, the outer surface having at least one of an increased surface area and an increased surface energy, wherein he at least one of the increased surface area and the increased surface energy of the outer surface facilitates the retention of sprayed fluid thereon.

In yet another form thereof, the present invention provides a method of covering a spraying device of a robot, including: providing a first portion of flexible polymer, the first portion of flexible polymer having an outer surface, the outer surface having a surface area and a surface energy; processing the first portion of flexible polymer to increase at least one of the surface energy and the surface area of the outer surface, whereby the at least one of the increase surface energy and the increased surface area of the outer surface facilitates the retention of fluid thereon; and forming the first portion of flexible polymer into a cover structured and arranged to envelop at least a portion of the spraying device of the robot.

### BRIEF DESCRIPTION OF THE DRAWINGS

The above-mentioned and other features and advantages of this invention, and the manner of attaining them, will become more apparent and the invention itself will be better understood by reference to the following description of an embodiment of the invention taken in conjunction with the accompanying drawings, wherein:

FIG. 1 is a perspective view of a paint booth including a vehicle body traveling therethrough and a painting robot covered by a robot cover according to the present invention;

FIG. 2 is a fragmentary cross-sectional view of the robot cover of FIG. 1;

FIG. 3 is a fragmentary cross-sectional view of another exemplary embodiment of the robot cover of FIG. 1; and

FIG. 4 is a fragmentary cross-sectional view of another exemplary embodiment of the robot cover of FIG. 1.

Corresponding reference characters indicate corresponding parts throughout the several views. Although the drawings represent embodiments of the present invention, the drawings are not necessarily to scale and certain features may be exaggerated in order to better illustrate and explain the present invention. The exemplifications set out herein illustrate embodiments of the invention, in several forms, and such exemplifications are not to be construed as limiting the scope of the invention in any manner.

### DETAILED DESCRIPTION

The embodiments disclosed below are not intended to be exhaustive or limit the invention to the precise form disclosed in the following detailed description. Rather, the embodiments are chosen and described so that others skilled in the art may utilize its teachings.

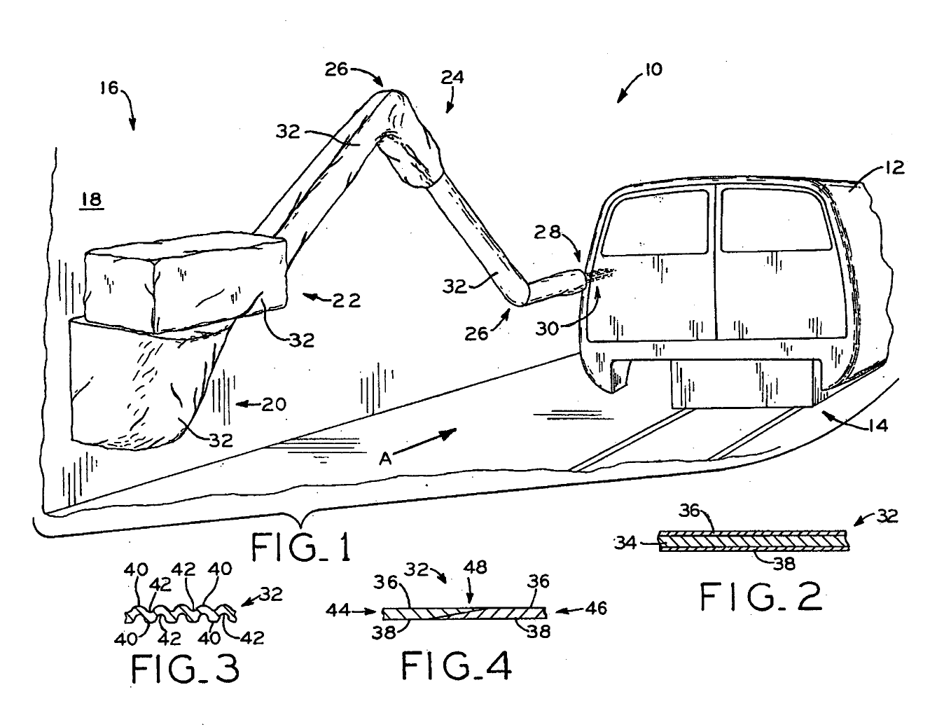

Referring to FIG. 1, paint booth 10 is shown including vehicle body 12 positioned on conveyor 14. Conveyor 14 moves vehicle body 12 along the assembly line to various assembly stations. Additionally, robot 16 is secured within paint booth 10 to wall 18. Robot 16 may be a flexible automation robot, i.e., a robot capable of articulation about a plurality of axes, or a hard automation robot, i.e., a robot that is generally stationary or capable of movement along only a single axis. Robot 16 is secured to wall 18 via base 20. Connected to base 20 of robot 16 is body 22 and arm 24. Body 22 may be actuated to rotate relative to base 20. Similarly, arm 24 may be actuated to move at pivots 26. The actuation of body 22 and arm 24 allows for robot 16 to assume numerous positions as vehicle body 12 moves through paint booth 10 on conveyor 14. At the end of arm 24 is a device for spraying fluid material, which in this exemplary embodiment comprises a spray gun with one or more spray nozzles 28, which provides an exit for pressurized paint therethrough. As the paint travels through spray nozzle 28 it is atomized and dispersed as paint 30. Atomized paint 30 leaving nozzle 28 is propelled toward vehicle body 12. While described herein as emitting atomized paint 30, robot 16 may be used in conjunction with any fluid. For example, robot 16 may be used to apply paint, primer, clear coat, adhesives, coatings, and/or depositions to an object.

During operation of conveyor 14, vehicle body 12 is moved in the direction of arrow A through paint booth 10. As vehicle body 12 moves through paint booth 10, robot 16 moves, as discussed above, via body 22 and pivots 26 of arm 24 to position spray nozzle 28 at various points along vehicle body 12. In this manner, the actuation of robot 16 and the cooperative movement of vehicle body 12 through paint booth 10 provide for the substantial entirety of vehicle body 12 to be coated with atomized paint 30. To protect robot 16 from atomized paint 30 which fails to contact vehicle body 12 during the painting operation, i.e., overspray, cover 32 may be placed over base 20, body 22, and arm 24 of robot 16. In alternative embodiments (not shown), cover 32 may be configured to envelop a spray gun or other spraying device, possibly operably connected to a robot, and thus protect that spraying mechanism from residue build up.

As depicted herein, cover 32 is assembled to form a one-piece, integral cover. In another exemplary embodiment, cover 32 may be divided into individual, distinct components, one component covering each of base 20, body 22, and arm 24, for example. Additionally, cover 32 may by sized larger than the individual components of robot 16 to facilitate the placement of cover 32 on robot 16. Further, to retain cover 32 in position on robot 16, cover 32 may include fasteners, such as elastic bands, tape, snaps, zippers, Velcro®, a continuously interlocking strip fastener, i.e., Ziploc®, and/or sliders. Velcro® and Ziploc® are registered trademarks of Velcro Industries, B.V. and S.C. Johnson & Son, Inc., respectively. Additionally, the fasteners may be independent of cover 32 and connected thereto after cover 32 is properly positioned on robot 16. To facilitate movement of the joints or articulating areas of robot 16, cover 32 may include portions having folds, pleats, gussets, or darts, for example. Alternatively, in another embodiment (not shown), the polymer may be provided in a sticky roll, sheet, or perforated sheet film version wherein pieces of the polymer material may simply be installed onto the robot or spraying equipment by sticking or placing such adhesive polymer directly or indirectly on the robot or spraying equipment surface.

As depicted in FIGS. 1 and 2, cover 32 substantially surrounds robot 16 to prevent atomized paint 30 from contacting robot 16. Additionally, cover 32 is formed from a flexible polymer, which allows robot 16 to move substantially unrestricted. Any flexible, extrudeable polymer capable of withstanding the manufacturing process described herein may be used to form cover 32. For example, low density polyethylene, linear low density polyethylene, high density polyethylene, ethylene-vinyl acetate copolymer, polypropylene, polyurethane, polyester, polyether, nylon, polyvinyl chloride, polyvinyl acetate, polyvinyl alcohol, latexes, and any polymer or copolymer of the foregoing or any other combination thereof. Further, by replacing cotton, polyester, or other fibrous material with a low cost polymer, the overall cost of cover 32 is substantially reduced. As a result, after cover 32 reaches the end of its useful life, cover 32 may be readily replaced, eliminating the need to reprocess, treat, or otherwise clean cover 32. Thus, when cover 32 is sufficiently saturated with wet or dry atomized paint 30 or otherwise becomes ineffective, cover 32 is removed from robot 16 and replaced by a new cover 32. Additionally, if cover 32 is formed from a water soluble material, for example polyvinyl alcohol, cover 32 may be placed in the paint wastewater for disposal.

In one exemplary embodiment, the polymer has an increased surface energy or dyne level. By increasing the surface energy of the polymer, the total energy of the surface of the polymer is correspondingly increased. Specifically, a surface has both a surface energy, i.e., a surface tension, which is a quantification of the disruption of molecular bonds that occurs when a surface is formed, and a surface area, which quantifies the amount of surface that is exposed in units of area. The product of the surface energy and the surface area is the total energy of the surface. Thus, by increasing one or both of the surface energy and the surface area the total energy of a surface is correspondingly increased. To obtain an increased surface energy, the polymer is processed in a manner that results in the polymer having a surface energy after processing that is greater than the surface energy of the polymer prior to processing. For example, the polymer may be processed to have an increased surface energy by using any of the methods set forth in detail below, either alone or in combination with one another. By increasing the surface energy of the polymer, the total energy of the surface of the polymer is increased and atomized paint 30 will initially be more readily retained by cover 32 due to the correspondingly increased wettability and adhesivity of cover 32.

In one exemplary embodiment, the polymer is subjected to corona treatment to increase the surface energy of the polymer. For example, corona treatment has been used to create a processed polymer that has dyne levels of 32 to 68. As a result of the corona treatment and the increased surface energy, total energy of the surface of the polymer is increased, causing a corresponding increase in the wettability and adhesivity of the polymer's surface. The document “Corona Treatment: An Overview” by David A. Markgraf (Senior Vice President of Enercon Industries Corporation) discloses one example of a corona treatment, and the disclosure is expressly incorporated by reference herein (as submitted in the Information Disclosure Statement filed on even day herewith).

Referring to FIG. 2, the fragmentary cross-section of cover 32 is shown depicting center region 34 and opposing outer surfaces 36, 38. In this embodiment, outer surfaces 36, 38 have both been processed to increase the surface energy of cover 32. Specifically, in this embodiment, outer surfaces 36, 38 have been subjected to corona treatment, in the form of a corona discharge. A corona discharge occurs when a current is developed at an electrode of high potential in a neutral fluid, such as air, resulting in the ionization of the surrounding fluid, which may then slowly diffuse to a second, grounded electrode. By moving cover 32 through the neutral medium, which now contains ionized particles, and over the grounded electrode, which may be in the form of a grounded roller, activation energy is transferred from the ionized particles to outer surfaces 36, 38 of the polymer. This may result in the breaking of polymeric chains forming polymer 32 and the creation of radicals. The chains and radicals will rapidly react with further particles or the environment, for example. These reactions may form both polar and hydrogen bonds along outer surfaces 36, 38 which, resultantly, increase the surface energy of the polymer. Thus, the areas depicted in FIG. 2 as surfaces 36, 38 are areas of additional molecular bonding having a higher surface energy than the unprocessed polymer. In another exemplary embodiment, only one of outer surfaces 36, 38 are processed to increase the surface energy of the exposed surface of cover 32. While other processes, such as plasma modification and surface grafting, discussed in detail below, may result in outer surfaces 36, 38 having higher surface energies than the surface energies that result from corona treatment, corona treatment substantially increases the surface energy of outer surfaces 36, 38 at a cost that is substantially less than other treatment methods. Thus, corona treatment provides a relatively economical method of substantially increasing the surface energy of cover 32 and, specifically, outer surfaces 36, 38.

In another exemplary embodiment, cover 32 is subjected to flame treatment to increase the surface energy of outer surfaces 36, 38 by causing oxidation at outer surfaces 36, 38. Chapter 6 of the book Polymer Surfaces: From Physics to Technology by Fabio Garbassi, Marco Morra, and Ernesto Occhiello and Chapter 7 of the book Polymer Surface Modification and Characterization by Chi-Ming Chan both disclose an overview of the flame treatment process, and the disclosures are expressly incorporated by reference herein (as submitted in the Information Disclosure Statement filed on even day herewith). In this embodiment, a burner is connected to a fuel source that is subjected to combustion, resulting in the burning of the fuel at the burner. In one exemplary embodiment, a plurality of burners are used. The flame generated at the burner as a result of the combustion of the fuel and oxygen in the ambient air creates a plasma. Outer surfaces 36, 38 are then passed through the plasma. By passing outer surfaces 36, 38 through the plasma, outer surfaces 36, 38 experience oxidation and various functional chemical groups that increase wettability of cover 32 may be formed and/or deposited on outer surfaces 36, 38.

In order to expose both of outer surfaces 36, 38 to flame treatment, one of outer surfaces 36, 38 may be passed through the plasma first. Then, cover 32 may be rotated 180 degrees and the other one of outer surfaces 36, 38 may then be passed through the plasma. Additionally, the flame treatment process may be modified to achieve an optimal increase in surface energy by changing the flame composition, e.g., changing the fuel, changing the combustion conditions, e.g., changing the air to fuel ratio, altering the distance between cover 32 and the flame, and/or adjusting the speed at which cover 32 passes through the plasma. In one exemplary embodiment, hydrogen may be used as the fuel and, upon combustion with oxygen, creates only water vapor as a byproduct. As a result, cover 32 is not negatively impacted by a deposition of contaminants created during the combustion process.

In yet another exemplary embodiment, cover 32 is subjected to plasma modification. While the generic term “plasma modification” may include both corona treatment and flame treatment, as used herein plasma modification requires the exposure of cover 32 to a plasma in an environment having a pressure less than atmospheric pressure, i.e., in a vacuum. In contrast, both corona treatment and flame treatment are performed in ambient air and, therefore, at atmospheric pressure. Chapter 6 of the book Polymer Surfaces: From Physics to Technology by Fabio Garbassi, Marco Morra, and Ernesto Occhiello and Chapter 6 of the book Polymer Surface Modification and Characterization by Chi-Ming Chan both disclose overviews of plasma modification processes, and the disclosures are expressly incorporated by reference herein (as submitted in the Information Disclosure Statement filed on even day herewith). In this embodiment, cover 32 may be exposed to a plasma formed from an oxygen containing substance, such as water or even oxygen itself, a nitrogen containing substance, such as ammonia, or a fluorine containing substance, such as tetrafluoromethane, for example. Additionally, the plasma may be formed from a combination of substances, such as a combination of oxygen and tetrafluoromethane.

A plasma modification system may include a vacuum chamber having a pair of opposing electrodes, i.e., a polarized anode and a grounded cathode, positioned therein. Additionally, the vacuum chamber may be configured to include a pumping and/or gas induction system that provides the substance, such as water, ammonia, or tetrafluoromethane, that will form the plasma to the interior of the vacuum chamber. As the substance is provided to the vacuum chamber, a plasma is formed between the two electrodes, which results in the formation of various excited chemical species. These excited chemical species that define the plasma may than react with outer surfaces 36, 38 of cover 32 as cover 32 is drawn between the opposing electrodes. As a result, the surface energy of outer surfaces 36, 38 of cover 32 is increased.

In another exemplary embodiment, cover 32 is subjected to a surface grafting. Surface grafting involves the bonding of new macromolecules to a substrate, such as cover 32. Chapter 7 of the book Polymer Surfaces: From Physics to Technology by Fabio Garbassi, Marco Morra, and Ernesto Occhiello and Chapter 5 of the book Polymer Surface Modification and Characterization by Chi-Ming Chan both disclose overviews of surface grafting processes, and the disclosures are expressly incorporated by reference herein (as submitted in the Information Disclosure Statement filed on even day herewith). In one embodiment, surface grafting of a monomer onto cover 32 is achieved using a mutual irradiation method. In one exemplary embodiment of a mutual irradiation method, cover 32 is presoaked in a solution including a monomer and an initiator. In one exemplary embodiment, cover 32 is continuously fed into a container filled with the solution. After presoaking, cover 32 is received by a reactor that is filled with nitrogen to provide a positive pressure during the remaining steps of the process. Once within the reactor, cover 32 is irradiated, such as by exposure to ultraviolet irradiation. Alternatively, cover 32 may be irradiated by exposure to electron beam irradiation, x-rays, γ-rays, infrared irradiation, or visible light. The exposure to the irradiation causes diffusion of the monomer and initiator into amorphous regions of cover 32. In other exemplary embodiments, the presoaking step may be eliminated and cover 32 may be exposed to the monomer in one of the vapor phase and the liquid phase substantially contemporaneously with exposure to the irradiation. However, by utilizing the presoaking step, the amount of time that cover 32 must remain in the reactor is substantially lessened.

In addition to the mutual irradiation method of surface grafting, cover 32 may be subjected to surface grafting in a two-step process that includes preirradiating cover 32. In this process, cover 32 is first subjected to irradiation, such as ultraviolet irradiation, in air. Alternatively, cover 32 may be subjected to irradiation by exposure to electron beam irradiation, x-rays, γ-rays, infrared irradiation, or visible light. Once exposed to irradiation, cover 32 is then passed through a reactor containing the monomer in one of a vapor phase and a liquid phase. By exposing cover 32 to irradiation prior to exposing cover 32 to a monomer, the preirradiation method of surface grafting requires that particular attention is paid to the irradiation atmosphere and the atmosphere through with cover 32 may travel prior to exposure to the monomer, as these atmospheres will impact the ultimately effectiveness of the surface grafting. Irrespective of the method used, by grafting an appropriate monomer onto outer surfaces 36, 38 of cover 32, the overall surface energy of cover 32 may be increased.

In another exemplary embodiment, cover 32 may be subjected to acid oxidation in order to increase the surface energy of cover 32. Chapter 7 of the book Polymer Surfaces: From Physics to Technology by Fabio Garbassi, Marco Morra, and Ernesto Occhiello discloses various acid oxidation processes, and the disclosure is expressly incorporated by reference herein (as submitted in the Information Disclosure Statement filed on even day herewith). For example, cover 32 may be subjected to chromic acid etching. In this process, a sulfuric acid solution is saturated with chromium trioxide. Cover 32 is then passed through the resulting chromic acid solution causing a series of reactions that oxidize outer surfaces 36, 38 of cover 32. Specifically, the Cr(VI) in the chromic acid solution attacks tertiary carbons on the polymer chains defining outer surfaces 36, 38 of cover 32. This causes the formation of a Cr(VI) ester intermediate and, ultimately, the formation of an alcohol. This alcohol then rapidly reacts to produce scission products containing carbonyl groups. These carbonyl groups may then be further oxidized to form carboxylic acids. As a result of the oxidation of outer surfaces 36, 38, the wettability of cover 32 is increased. Thus, fluids that contact outer surfaces 36, 38 of cover 32 after acid oxidation have a significantly lower contact angle than fluids that contact outer surfaces 36, 38 of cover 32 before acid oxidation. While described herein with specific reference to chromic acid, acid oxidation of cover 32 may be performed using any suitable acids or solutions thereof, such as a piranha solution, i.e., a solution of sulfuric acid and hydrogen peroxide, for example.

Additionally, cover 32 may be subjected to radiation induced oxidation to increase the surface energy thereof. Chapter 6 of the book Polymer Surfaces: From Physics to Technology by Fabio Garbassi, Marco Morra, and Ernesto Occhiello discloses various radiation induced oxidation processes, and the disclosure is expressly incorporated by reference herein (as submitted in the Information Disclosure Statement filed on even day herewith). For example, cover 32 may be subjected to ultraviolet irradiation. In another exemplary embodiment, cover 32 is exposed to x-ray and/or γ-ray irradiation. Alternatively, cover 32 may be exposed to electron beam irradiation. To expose cover 32 to irradiation, such as electron beam irradiation, the polymeric material used to form cover 32 may be placed on a conveyor or rollers, for example, which pass below an irradiation source, such as an electron gun generating an electron beam, that is directing irradiation toward the conveyor or rollers. In one exemplary embodiment, an electron gun may be used to generate electron beam irradiation in the form of low energy electrons, i.e., electrons having an energy of 25 keV or less. Irrespective of the irradiation method used, by exposing cover 32 to irradiation in the presence of oxygen, e.g., in the ambient environment, outer surfaces 36, 38 of cover 32 may be oxidized. This, in turn, increases the wettability, adhesion, and antistatic characteristics of outer surfaces 36, 38 of cover 32 by increasing the surface energy of, and, correspondingly, the total energy of, outer surfaces 36, 38.

In another exemplary embodiment, the surface energy of cover 32 may be increased by exposure to laser treatments, i.e., exposure to the photons generated by a laser, in accordance with known techniques. Alternatively, cover 32 may be subjected to ion beam treatments, metallization, and/or sputtering in accordance with known techniques. Chapter 6 of the book Polymer Surfaces: From Physics to Technology by Fabio Garbassi, Marco Morra, and Ernesto Occhiello provides an overview of laser treatments, ion beam treatments, metallization, and sputtering, and the disclosure is expressly incorporated by reference herein (as submitted in the Information Disclosure Statement filed on even day herewith). By utilizing any of laser treatments, ion beam treatments, metallization, and sputtering, the surface energy of outer surfaces 36, 38 of cover 32 may be increased.

In contrast to having an increased surface energy, in another exemplary embodiment, shown in FIG. 3, the polymer of cover 32 has an increased surface area. Specifically, to obtain an increased surface area, the polymer is processed in a manner that results in the polymer having a surface area after processing that is greater than the surface area of the polymer prior to processing. For example, the polymer may be processed to have an increased surface area by using any of the methods set forth in detail below, either alone or in combination with one another. Additionally, in one exemplary embodiment, the polymer may be processed to have both an increased surface area and an increased surface energy. By increasing the surface area of the polymer, the amount of fluid, such as paint, that may be retained in the polymer is correspondingly increased, as described in detail below. Additionally, as discussed above, increasing the surface area of the polymer also results in a corresponding increase in the total energy of the surface of the polymer.

In one exemplary embodiment, the polymer of cover 32 is subjected to an embossing process. The document “About The Technology of Embossing for Commercial Application” (from www.embossingtechnologies.com/technology.htm on Mar. 8, 2007) discloses one example of an embossing process, and the disclosure is expressly incorporated by reference herein (as submitted in the Information Disclosure Statement filed on even day herewith). Embossing creates a series of raised projections and corresponding depressions on cover 32. For example, by subjecting cover 32 to embossing, one side of cover 32 may have a projection extending from the surface thereof and the opposing side of cover 32 may have a corresponding depression extending below the surface thereof.

By creating a series of projections and depressions, embossing increases the surface area of cover 32 per unit length. For example, if a one inch by one inch square of cover 32 has a surface area of one square inch prior to embossing, i.e., is substantially flat, the same one inch by one inch square will have a surface area greater than one square inch, e.g., 1.25 square inches, after embossing. By increasing the surface area of the polymer, the embossing process increases the amount of paint that may be retained by the polymer by providing more areas for receiving the paint and correspondingly increases the total energy of the surface of the polymer. Additionally, the embossing process increases the flexibility of the polymer. For example, the polymer may be subjected to a hot embossing process in which the polymer is heated to a temperature above its glass transition temperature and pressed in a mold. Sufficient force is exerted by the mold on the polymer to cause the polymer to take a shape corresponding to the exterior surface of the mold. Then, once the polymer cools, the polymer will retain the shape formed by the mold.

In another exemplary embodiment, the polymer may be subjected to a rotary embossing process. In a rotary embossing process, the polymer passes between two rollers. The rollers may both be engraved with patterns that engage one another as the polymer passes between the two rollers. Alternatively, only one of the rollers may be engraved. As the polymer passes between the rollers, the polymer encounters a pressure sufficient to force the polymer into the engraved portions of the roller. As a result, the polymer exiting the rollers has a raised pattern corresponding to the pattern of the engraving on the roller. For example, as shown in FIG. 3, the embossing process may create ridges 40 and grooves 42 in the polymer. In one exemplary embodiment, ridges 40 and grooves 42 may form a pattern, including but not limited to grit, natural grit, diamond, or honeycomb patterns. When paint contacts the polymer at one of ridges 40, the paint may fall into and be retained by an adjacent groove 42. Additionally, as grooves 42 become filled with paint, ridges 40 provide additional surface area upon which further amounts of paint may be retained.

In addition to embossing, other exemplary methods may be used to increase the surface area of cover 32. For example, the polymeric material forming cover 32 may be roughened by abrasion, such as by wire brushing, sanding, or sand blasting, for example. Alternatively, cover 32 may be etched with a corrosive agent, such as the acids disclosed in detail above with reference to acid oxidation, or embedded with a particulate or fibrous material, such as silica, nylon, or polyester, for example, in the polymer resin. In another exemplary embodiment, the polymer forming cover 32 may be subjected to any of the chemical modification processes described above in order to increase the surface area of, e.g., roughen, the polymer. For example, the polymer may be subjected to chemical oxidation, plasma modification, corona treatment, or graft modification.

Additionally, in one exemplary embodiment, embossing is used in combination with one of the other methods disclosed herein for increasing the surface area of the polymer forming cover 32. As a result of utilizing different methods of increasing the surface area of the polymer in combination, the polymer may be imparted with surface features that are formed to different size scales. For example, embossing generally produces surface features having a size in excess of 10 microns. In contrast, other methods of increasing the surface area of the polymer forming cover 32 disclosed herein may produce surface features of less than 10 microns. Advantageously, by manufacturing cover 32 to have surface features having different size scales, a greater increase in the wettability of cover 32 may be obtained.

The process of increasing the surface energy of the polymer may be performed in conjunction with the process of increasing the surface area of the polymer. As a result, a greater increase in the total energy of the surface of the polymer may be obtained than would otherwise result from increasing only one of the surface energy and the surface area of the polymer. For example, the polymer may be processed to increase its surface energy and subsequently processed to increase its surface area. Thus, in one exemplary embodiment, the polymer may be subjected to a corona treatment, for example, and then subjected to an embossing process, for example. Alternatively, the polymer may be processed to increase its surface area and subsequently processed to increase its surface energy. Thus, in another exemplary embodiment, the polymer may be subjected to an embossing process, for example, and then subjected to a corona treatment, for example. Moreover, in another exemplary embodiment, the process of increasing the surface energy of the polymer may be performed substantially concurrently with the process of increasing the surface area of the polymer. In addition, other methods of increasing the attraction and adherence of paint and other residue may be applied to the polymer material of the cover, such as a coating of material which has such attraction and adherence properties.

To increase the surface energy and/or surface area of cover 32, and, correspondingly, increase the total energy of the surface of the polymer, individual sections of the polymer may be cut and individually subjected to processing, such as corona treatment and/or embossing, as described in detail above. By processing cover 32 as a flat layer of material, the difficulty of processing cover 32 may be decreased and the results of the processing may be improved. Alternatively, in another exemplary embodiment, cover 32 may be assembled in its entirety and subjected to processing to increase its surface energy and/or surface area. In yet another exemplary embodiment, the polymer may be treated as received, before any assembly occurs. For example, cover 32 may be formed from tubular plastic film which may be subjected to processing as received. In one exemplary embodiment, the tubular plastic film forming cover 32 may be tapered, easing the manufacture of cover 32.

To assemble cover 32, individual sections of polymer may be joined by heat or thermal sealing. In another embodiment, edges of a single section of polymer may be joined by thermal sealing to form a tubular shape, for example. Referring to FIG. 4, in order to thermal seal individual sections of polymer together to form cover 32, the edges of the individual sections, such as sections 44, 46, are slightly overlapped. Along the overlap, heat and, in some embodiments, pressure is applied to the overlapped sections of the individual sections of polymer. In one exemplary embodiment, the thermal sealing process is automated. As a result of the thermal sealing, the individual polymer sections are substantially permanently joined to form cover 32 at joint or weld 48. Advantageously, the use of thermal sealing eliminates the cost of thread and also eliminates the need for labor to sew individual sections of cover 32 together, lowering the overall manufacturing costs. Additional sealing techniques, such as ultrasonic welding, laser welding, sound and/or pressure sealing, sewing, thermal molding, pressure molding, vacuum molding, blow molding, and/or gluing may also be used individually or in combination with thermal sealing to form cover 32. For example, if gluing is desired, commercial adhesives, such as Loctite® All Plastics, Loctite® 3355, which is a delay cured ultraviolet initiated epoxy, 3M™ Scotch-Grip™ plastic adhesive, or Plastic-Fuse® may be used. Loctite® is a registered trademark of Henkel Loctite Corporation of Rocky Hill, Conn. 3M™ and Scotch-Grip™ are trademarks of Minnesota Mining and Manufacturing Company of St. Paul, Minn. and Plastic-Fuse® is a registered trademark of Pacer Technology Corporation of Rancho Cucamonga, Calif.

As indicated above, in one exemplary embodiment, laser welding may be used to thermally seal opposing sections 44, 46 (FIG. 4) of polymer together to form cover 32. An article published in volume 34 of Optics and Lasers in Engineering, entitled “High-speed laser welding of plastic films”, by J. P. Coelho, M. A. Abreu, and M. C. Pires discloses an exemplary process for laser welding polymers, and the disclosure is expressly incorporated by reference herein (as submitted in the Information Disclosure Statement filed on even day herewith). Additional information regarding laser welding can be found in the document “Laser Welding” (from www.uslasercorp.com/envoy/welding.html on Feb. 26, 2008) and the document “Laser Welding Overview” (from www.engineersedge.com/manufacturing/laser welding.htm on Feb. 26, 2008), and the disclosures are expressly incorporated by reference herein (as submitted in the Information Disclosure Statement filed on even day herewith). In laser welding, a laser beam is passed through a lens which focuses the beam. The beam is then directed at an overlapping portion of individual sections of the polymer that are being joined at weld 48 to form at least a portion of cover 32. When the laser beam contacts the polymer, the light energy generated by the laser beam is converted to thermal energy by the polymer. This thermal energy melts the overlap sections of the polymer at the point of contact with the laser beam. Thus, as the individual sections move through the laser beam, a seam is created that forms a laser weld between the opposing portions of polymer.

As indicated above, ultrasonic welding may also be used to thermally seal opposing portions of polymer that will cooperate to form a larger portion of cover 32 together. An article published in volume 42 of Ultrasonics, entitled “Welding characteristics of 27, 40 and 67 kHz ultrasonic plastic welding systems using fundamental- and higher-resonance frequencies”, by Jiromaru Tsujino, Misugi Hongoh, Masafumi Yoshikuni, Hidekazu Hashii, and Tetsugi Ueoka discloses exemplary processes for the ultrasonic welding of polymers, and the disclosure is expressly incorporated by reference herein (as submitted in the Information Disclosure Statement filed on even day herewith). Additional information regarding ultrasonic welding is also provided in an article in volume 124 of the Journal of Manufacturing Science and Engineering, entitled “Mechanical Analysis of Ultrasonic Bonding for Rapid Prototyping”, by Yuan Gao and Charalabos Doumanidis, and the disclosure is expressly incorporated by reference herein (as submitted in the Information Disclosure Statement filed on even day herewith). In ultrasonic welding, the first layer of material is positioned against an anvil. The second layer of material is positioned so that it overlaps the first layer. The positioning of the second layer to overlap the first layer may be performed either before or after the first layer is positioned on the anvil. Once the second layer is positioned to overlap the first layer, a welding tip connected to a horn which is, in turn, connected to a transducer is lowered to press the welding tip against the second layer. The welding tip then undergoes high frequency, low amplitude vibrations that are transferred to the interface between the first and second polymer layers to generate frictional heat. In one exemplary embodiment, the vibrations have a frequency of between 20,000 Hz and 70,000 Hz. These vibrations are caused by the generation and direction ultrasonic energy to the welding tip. The frictional heat generated by the vibrations causes a small portion of the polymer layers to melt and join. Once joined, the vibrations are stopped and the welding tip is lifted from the polymer. The joined sections of polymer may now be removed from the anvil or repositioned for additional ultrasonic welding.

Sections of cover 32 are shaped, structured, and arranged to substantially surround at least a portion of arm 24 of robot 16. Cover 32 effectively shields robot 16 from atomized particulate by surrounding, enveloping, or otherwise blocking fluid flow from outside of cover 32 to robot 16. Such structure and arrangement may be accomplished from polymer created in a tubular form, or from laminar polymer sheets, or through a molding process, including but not limited to thermal, vacuum, blow, and pressure molding processes. As described above, such structure and arrangement may be accomplished through several suitable manufacturing processes.

In another exemplary embodiment, cover 32 is assembled with surfaces 36, 38 and center region 34 each being individual, distinct layers of polymer. In this embodiment, the layers defining surfaces 36, 38 are each subjected to processing, such as corona treatment and/or embossing, to increase their surface tension and/or surface area. In one exemplary embodiment, the layers defining surfaces 36, 38 are formed from a high surface energy polymer, such as poly(vinyl alcohol), poly(vinyl pyrrolidone), poly(acrylic acid), polyamine, poly(hydroxyethyl methacrylate), for example. The center layer, i.e., region 34, may then be formed from a low density polyethylene or another polymer having superior strength and/or wear properties. In addition, another layer may be added to improve the tear resistance, i.e., the wear properties, of the final polymer. For example, an elastomer layer may be added to the multilayer construct and may define a portion of center region 34. In one exemplary embodiment, the elastomer is a vulcanizable rubber, such as natural rubber, butadiene rubber, and isoprene rubber, for example.

In another exemplary embodiment, the elastomer is a thermoplastic extrudable rubber, such as a Kraton® brand polymer. Kraton® is a registered trademark of Kraton Polymers, LLC of Houston, Tex. In this embodiment, extremely thin layers of the thermoplastic extrudable elastomer may be used to achieve substantially improved tear resistance.

These layers defining surfaces 36, 38 are then assembled on opposing sides of the polymer layer defining center region 34, such as by laminating. In one exemplary embodiment, the layers are joined to the polymer layer defining center region 34 by heat sealing, for example, which is described in detail above. In one exemplary embodiment, surfaces 36, 38 have a thickness which is less than the thickness of center region 34. This embodiment may be formed by using copolymers, such as copolymers formed from the polymers set forth herein.

In another exemplary embodiment, instead of defining each of outer surfaces 36, 38 and center region 34 as separate polymeric layers, cover 32 may be formed by blending any of the polymers described above with another one of the polymers described above. Chapter 8 of the book Polymer Surfaces: From Physics to Technology by Fabio Garbassi, Marco Morra, and Ernesto Occhiello discloses an overview of bulk modification processes, and the disclosure is expressly incorporated by reference herein (as submitted in the Information Disclosure Statement filed on even day herewith). In this manner, a high energy polymer may be blended with a lower energy polymer that has superior strength and/or wear characteristics. For example, by blending a lower energy polymer with less than 50 percent, and as little as 1 percent, high energy polymer to create a blended polymer, the blended polymer may have a substantially higher surface energy as compared to the low energy polymer. Additionally, the blended polymer may also be made porous to further increase the fluid absorption and retention characteristics of the polymer. For example, the blended polymer may include a fugitive material, such as a high boiling point solvent, that may be removed from the blended polymer to define a series of pores therein. These pores provide an increased volume that may receive and retain a fluid, such as paint, therein.

Alternatively, instead of defining separate polymeric layers, outer surfaces 36, 38 may be formed by coating one or more polymeric layers that define center region 34 with a compound having a higher total energy than center region 34. In this embodiment, center region 34 is coated with a compound that increases the total energy of the surface of the construct by forming a higher total energy outer surface, such as outer surfaces 36, 38, on center region 34. Thus, any compound that, once deposited on center region 34, has a greater total energy than the surfaces of center region 34 may be used to coat center region 34. In this manner, the compound may be used to coat both sides of center region 34, forming higher total energy outer surfaces 36, 38, or, alternatively, may be used to form only a single higher total energy outer surface, such as one of outer surfaces 36, 38. Additionally, the compound used to form outer surfaces 36, 38 may be applied by any of the techniques described herein above.

While the present invention relates to aiding the adherence of paint and other sprayed fluids to the cover of an automation, the inventor's work in this area also leads to an additional discovery relating to the repulsion of paint and other sprayed fluids. With adherence, the increase in total surface energy enhances the retention of the patent or other sprayed fluid. However, to repel such fluid a polarized surface energy is needed that repels the polarized state of the sprayed fluid. It is thus possible to include a polymer substrate or coating having enhanced anti-static and/or conductive properties and/or a polarized state, e.g. a chemically charged material coating, which repels sprayed fluid as is desired in some automation applications. In this charged material coating embodiment, a polymer film conducting electrostatic paint material charges from the anti-static “conductive” master batch resin additive. It is also possible to incorporate conductive threads in a polymer covering and use the conductive threads to create a polarized field sufficient to repel sprayed liquids.

While this invention as been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A cover configured for receipt on a spraying device of a robot, the spraying device adapted to disperse a fluid, the cover comprising:
a first portion of flexible polymer structured and arranged to envelop at least a portion of the spraying device of the robot, said polymer having an outer surface, said outer surface having an increased total energy, wherein the increased total energy of said outer surface facilitates the retention of sprayed fluid thereon.

2. The cover of claim 1, wherein said increased total energy of said outer surface of said polymer comprises an increased surface energy.

3. The cover of claim 2, wherein said polymer is at least one of corona treated, flame treated, plasma modified, surface grafted, acid oxidized, radiation induced oxidized, laser treated, ion beam treated, metallized, and sputtered.

4. The cover of claim 1, wherein said increased total energy of said outer surface of said polymer comprises an increased surface area.

5. The cover of claim 4, wherein said polymer is at least one of embossed, roughened, embedded with particulate material, embedded with fibrous material, and chemically modified.

6. The cover of claim 1, further comprising a second portion of flexible polymer, said second portion of flexible polymer secured to said first portion of flexible polymer.

7. The cover of claim 6, wherein said second portion of flexible polymer is thermally sealed to said first portion of flexible polymer.

8. The cover of claim 1, wherein the flexible polymer is selected from the group consisting of low density polyethylene, linear low density polyethylene, polypropylene, polyurethane, polyester, polyether, nylon, polyvinyl chloride, polyvinyl acetate, and polyvinyl alcohol.

9. The cover of claim 1, wherein said flexible polymer comprises a laminar sheet.

10. A combination comprising:
a robot having a base and a spraying device, said spraying device configured to disperse a fluid; and
a cover having a first portion of flexible polymer structured and arranged to envelop at least a portion of said spraying device of said robot, said polymer having an outer surface, said outer surface having an increased total energy, wherein the increased total energy of said outer surface facilitates the retention of sprayed fluid thereon.

11. The combination of claim 10, wherein said robot is a flexible automation robot.

12. The combination of claim 10, wherein said robot is a hard automation robot.

13. The combination of claim 10, wherein said increased total energy of said outer surface of said polymer comprises an increased surface energy.

14. The combination of claim 13, wherein said cover is at least one of corona treated, flame treated, plasma modified, surface grafted, acid oxidized, radiation induced oxidized, laser treated, ion beam treated, metallized, and sputtered.

15. The combination of claim 10, wherein said increased total energy of said outer surface of said polymer comprises an increased surface area.

16. The combination of claim 15, wherein said cover is at least one of embossed, roughened, embedded with particulate material, embedded with fibrous material, and chemically modified.

17. The combination of claim 10, wherein said cover further comprises a second portion of flexible polymer, said second portion of flexible polymer secured to said first portion of flexible polymer.

18. The combination of claim 17, wherein said second portion of flexible polymer includes an outer surface, said outer surface having at least one of an increased surface energy and an increased surface area, wherein said at least one of said increased surface energy and said increased surface area facilitates the retention of fluid thereon.

19. A method of covering a spraying device of a robot, comprising:
providing a first portion of flexible polymer, the first portion of flexible polymer having an outer surface, the outer surface having a surface area and a surface energy;
processing the first portion of flexible polymer to increase at least one of the surface energy and the surface area of the outer surface, whereby the at least one of the increased surface energy and the increased surface area of the outer surface facilitates the retention of fluid thereon; and
forming the first portion of flexible polymer into a cover structured and arranged to envelop at least a portion of the spraying device of the robot.

20. The method of claim 19, wherein the processing step further comprises subjecting the first portion of flexible polymer to at least one of corona treatment, flame treatment, plasma modification, surface grafting, acid oxidization, radiation induced oxidization, laser treatment, ion beam treatment, metallization, and sputtering.

21. The method of claim 19, wherein the processing step further comprises subjecting the first portion of flexible polymer to at least one of embossing, roughening, embedding with particulate material, embedding with fibrous material, and chemically modification.

22. The method of claim 19, further comprising the step of positioning the first portion of flexible polymer substantially around at least a portion of the spraying device of the robot.

23. The method of claim 22, further comprising the step of securing the first portion of flexible polymer to the spraying device of the robot.

24. The method of claim 19, further comprising the steps of providing a second portion of flexible polymer and securing the second portion of flexible polymer to the first portion of flexible polymer.

25. The method of claim 24, wherein the securing step further comprises one of thermally sealing, sound sealing, pressure sealing, sewing, thermal molding, pressure molding, vacuum molding, blow molding, and gluing, the first portion of flexible polymer to the second portion of flexible polymer.
